(19) United States
(12) Patent Application Publication
(10) Pub. No.: US 2025/0196519 A1
(43) Pub. Date: Jun. 19, 2025

(54) PRINTING APPARATUS

(71) Applicant: SEIKO EPSON CORPORATION, Tokyo (JP)

(72) Inventors: Naoto HAYAKAWA, MATSUMOTO-SHI (JP); Koji HIGUCHI, SHIOJIRI-SHI (JP)

(21) Appl. No.: 18/980,292

(22) Filed: Dec. 13, 2024

(30) Foreign Application Priority Data
Dec. 13, 2023 (JP) 2023209941

(51) Int. Cl. B41J 29/13

(52) U.S. Cl. CPC B41J 29/13

(57) ABSTRACT

A printing apparatus includes a roll body holding portion, a transport portion configured to transport roll paper from the roll body, a printing unit that performs recording on the roll paper, a support portion disposed to face the printing unit, a housing, and a first cover configured to be opened and closed and cover the roll body when the first cover is closed, the roll body holding portion and the first cover are disposed above the housing, a medium supply port for supplying the roll paper into the housing is installed on an upper surface of the housing, the first cover does not cover at least a portion of the medium supply port in a state in which the first cover is closed, and a second cover configured to cover a non-covered area not covered by the first cover in the medium supply port is included.

The present application is based on, and claims priority from JP Application Serial Number 2023-209941, filed Dec. 13, 2023, the disclosure of which is hereby incorporated by reference herein in its entirety.

### BACKGROUND

### 1. Technical Field

The present disclosure relates to a printing apparatus.

### 2. Related Art

In the related art, a printing apparatus that use both roll paper and cut paper is known. For example, JP-A-2016-182716 discloses a printing apparatus including a cover member that covers a roll body of roll paper.

However, in the printing apparatus described in JP-A-2016-182716, there is concern that dust enters a housing from a paper feed port through which cut paper is supplied. The entered dust may become adhered to a recording head or the like, causing printing defects. That is, there is a demand for a printing apparatus that curbs entrance of dust and reduces the printing defects.

### SUMMARY

A printing apparatus includes a roll body holding portion configured to hold a roll body of roll paper wound in a roll shape as a medium, a transport portion configured to unroll and transport the medium from the roll body held by the roll body holding portion, a printing unit configured to perform recording on the medium transported by the transport portion, a support portion disposed to face the printing unit and configured to support the medium, a housing configured to accommodate the transport portion, the printing unit, and the support portion therein, and a first cover configured to be opened and closed and cover the roll body held by the roll body holding portion when the first cover is closed, wherein the roll body holding portion and the first cover are disposed above the housing, a medium supply port for supplying the medium unrolled from the roll body to the inside of the housing is installed on an upper surface of the housing, the first cover does not cover at least a portion of the medium supply port in a state in which the first cover is closed, and when an area of the medium supply port not covered by the first cover when the first cover is closed is defined as a non-covered area, a second cover configured to cover the non-covered area is included.

### BRIEF DESCRIPTION OF THE DRAWINGS

FIG. 1 is a perspective view showing an exterior of a printing apparatus according to an embodiment.

FIG. 2 is a schematic diagram illustrating an internal configuration of the printing apparatus.

FIG. 3 is a cross-sectional perspective view showing a disposition of a first cover, a second cover, and the like.

FIG. 4 is a perspective view showing a configuration of the second cover.

FIG. 5 is a side view showing change in form of the second cover.

FIG. 6 is a perspective view showing a mechanism for attaching or detaching a third portion and a fourth portion of the second cover.

FIG. 7 is a side view showing a disposition of the first cover and the second cover when printing is performed on roll paper.

FIG. 8 is a side view showing a disposition of the first cover and the second cover when printing is performed on cut paper.

FIG. 9 is a side view showing a disposition of the first cover and the second cover

when a roll body is replaced.

FIG. 10 is a cross-sectional view showing a disposition of a grounding member.

FIG. 11 is a side view showing a location of a non-covered area when printing is performed on roll paper according to a comparative example.

### DESCRIPTION OF EMBODIMENTS

In an embodiment to be described below, a printing apparatus 1 capable of selectively using roll paper and cut paper as a medium will be illustrated and described with reference to the drawings. The printing apparatus 1 is a large format inkjet printer. A material of the cut paper and the roll paper referred to here is not limited to paper. The materials of the cut paper and the roll paper are roughly divided into paper-based materials and film-based materials. Specific examples include paper-based fine paper, cast paper, art paper, and coated paper, and film-based synthetic paper, polyvinyl chloride (PVC), polyethylene terephthalate (PET), and polypropylene (PP).

In the following figures, XYZ axes that are orthogonal coordinate axes are referred to, and a direction indicated by each arrow is a +direction, and a direction opposite the +direction is a −direction. A +Z direction may be referred to as an upward direction, and a −Z direction may be referred to as a downward direction. When the printing apparatus 1 is installed on a horizontal surface, a −Z direction is a vertical direction. In the following figures, a size of each member is different from an actual size for the convenience of illustration.

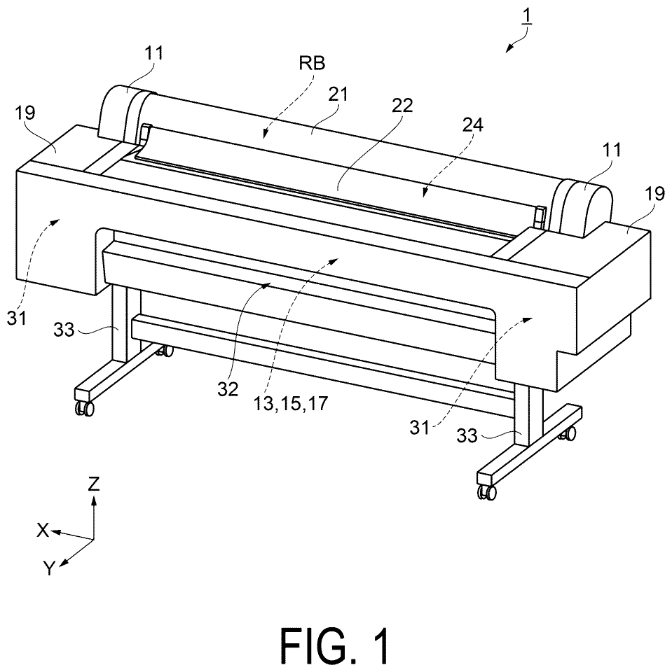

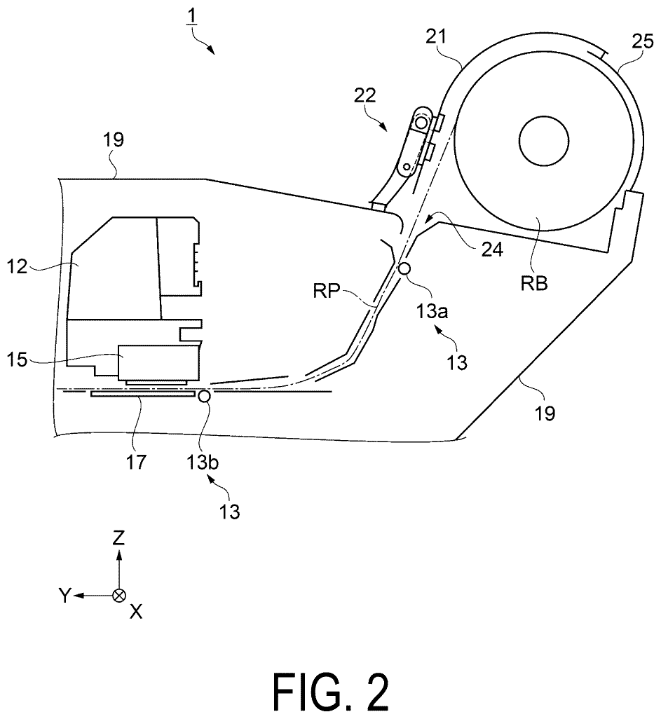

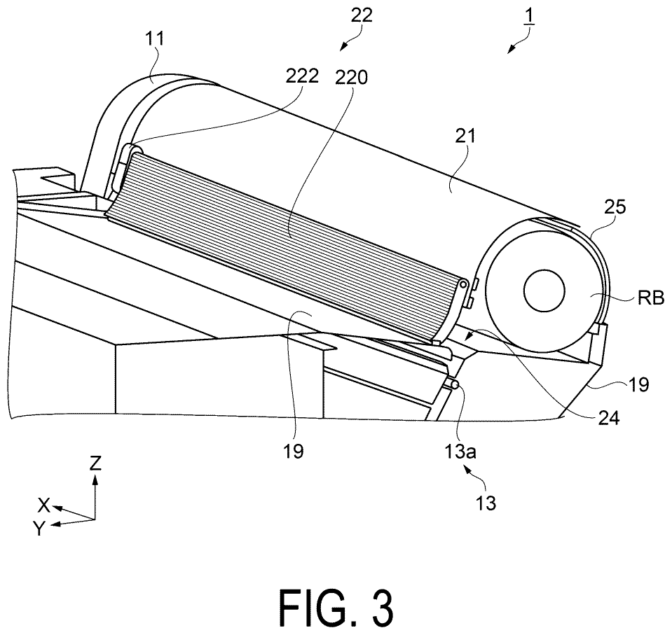

As illustrated in FIG. 1, the printing apparatus 1 according to the present embodiment includes a roll body holding portion 11, a transport portion 13, a printing unit 15, a support portion 17, a housing 19, a first cover 21, a second cover 22, a medium supply port 24, a cartridge accommodation portion 31, a paper discharge port 32, and leg portions 33. Here, FIG. 1, and FIGS. 2 and 3 to be described later show the printing apparatus 1 in a state in which roll paper is being printed on. In the printing apparatus 1, a form of the second cover 22 changes when printing is performed on the roll paper and when printing is performed on the cut paper.

Although not shown, the printing apparatus 1 also includes a control unit. The control unit is electrically coupled to each of components of the printing apparatus 1 including the above components, and controls these components in an integrated manner.

The control unit includes a CPU, a ROM, a RAM, and the like, which serve as an arithmetic execution unit. The ROM stores firmware executable by the CPU, data related to the firmware, and the like in a non-volatile manner. Further, the RAM temporarily stores data related to firmware that is executed by the CPU. The control unit may also include other peripheral circuits, and may include a storage unit capable of storing various programs or data, such as a control program or data related to the control program in a non-volatile manner.

The housing 19 is a generally rectangular parallelepiped elongated along the X-axis, and has an upper surface, a lower surface, and four side surfaces. The housing 19 accommodates the transport portion 13, the printing unit 15, the support portion 17, the cartridge accommodation portion 31, the control unit, and the like therein.

An upper surface of the housing 19 faces upward along an XY plane. A lower surface of the housing 19 faces downward along the XY plane. The roll body holding portion 11, the medium supply port 24, the first cover 21, and the second cover 22 are installed on the upper surface of the housing 19. The leg portions 33 are installed on the lower surface of the housing 19. The paper discharge port 32 is installed on the side directed to the +Y direction along an XZ plane among the four sides of the housing 19.

The roll body holding portion 11 is disposed on the housing 19 and protrudes upward from an end of the upper surface in the −Y direction. The roll body holding portion 11 rotatably holds a roll body RB of roll paper wound in a roll shape as a printing medium. Specifically, the roll body holding portion 11 supports both ends of the roll body RB so that a central axis of the roll body RB is along the X axis. The roll body RB rotates counterclockwise when viewed from an −X direction to supply the roll paper to the inside of the housing 19.

The leg portions 33 are structural members that support the housing 19 below the housing 19. The leg portions 33 are made of, for example, square metal tubes. Casters are installed below the leg portions 33. The casters make it easy to move the printing apparatus 1.

The first cover 21 is elongated along the X-axis and is disposed above the housing 19 and the roll body RB. The first cover 21 can be opened and closed with respect to the roll body RB held by the roll body holding portion 11. As described above, a state in which printing is performed on the roll paper is shown in FIG. 1, and the first cover 21 is closed. When the first cover 21 is closed, the first cover 21 covers the roll body RB held by the roll body holding portion 11. Opening and closing of the first cover 21 will be described later.

In a direction along the X-axis, a length of the first cover 21 is equal to or larger than that of the roll body RB. The first cover 21 is disposed along the side of the cylindrical roll body RB to protect the roll body RB.

The second cover 22 is installed on the first cover 21. The second cover 22 is an elongated member along the X-axis. In the direction along the X-axis, a length of the second cover 22 is approximately equal to that of the first cover 21. The second cover 22 covers a part of the medium supply port 24. The form of the second cover 22 changes depending on a situation of roll paper printing, cut paper printing, or the like. Change in form of the second cover 22 will be described later.

The cartridge accommodation portion 31 is located inside the housing 19 and is disposed near both ends in the direction along the X-axis. The cartridge accommodation portion 31 accommodates a plurality of ink cartridges that are used for printing of the printing apparatus 1. In the printing apparatus 1, the plurality of ink cartridges can be attached or detached to or from the cartridge accommodation portion 31 by opening a door (not shown).

The plurality of ink cartridges are individually filled with ink of each color, such as black, cyan, magenta, and yellow, for example. Each color ink is supplied from the corresponding ink cartridge to the printing unit 15 through a pipe and used for printing on the medium. An external ink tank may be installed outside the housing 19 instead of the cartridge accommodation portion 31. In this case, each color ink is supplied from the ink tank to the printing unit 15 through a tube or the like.

The paper discharge port 32 is disposed on the side of the housing 19 directed to the +Y direction. The paper discharge port 32 is an elongated opening along the X axis. In the direction along the X axis, a length of the paper discharge port 32 is larger than that of the medium. The paper discharge port 32 discharges the medium that has become printed matter by the printing unit 15.

Although not shown, an operating unit and a display unit related to an operation of the printing apparatus 1 are installed in the housing 19. The operating unit and the display unit are electrically coupled to the control unit. The operating unit includes operating buttons, and accepts various operations with respect to the printing apparatus 1 by an operator via the operating buttons. The display unit is, for example, a liquid crystal display, and displays various types of information related to the printing apparatus 1. The operating unit and the display unit may be an integrated touch panel type liquid crystal display, or the like.

As illustrated in FIG. 2, a rear cover 25 is disposed approximately in the −Y direction of the roll body RB. In the direction along the X-axis, a length of the rear cover 25 is equal to or greater than the length of the roll body RB. The rear cover 25 covers the −Y direction of the roll body RB. In the following description of FIG. 2, a state viewed from the −X direction will be described unless otherwise specified.

The first cover 21 covers an upper side of the roll body RB and a part thereof in the −Y direction. The first cover 21 supports the second cover 22 at an end in the +Y direction.

The first cover 21 and the rear cover 25 have a cross-sectional shape along a YZ plane that has a substantially arc shape, and have a shape that follows a circumferential surface of the roll body RB. The first cover 21, the rear cover 25, the second cover 22, and the housing 19 surround approximately the entire periphery of the circumferential surface of the roll body RB. This curbs adhesion of foreign matter such as dust to the roll body RB.

The roll body RB rotates counterclockwise to supply the roll paper RP to the inside of the housing 19 from the medium supply port 24.

The medium supply port 24 is installed on the upper surface of the housing 19. The medium supply port 24 supplies the roll paper RP as a medium unrolled from the roll body RB to the inside of the housing 19. The medium supply port 24 also supplies cut paper, which will be described later, to the inside of the housing 19.

The transport portion 13 includes transport rollers 13a and 13b. The transport rollers 13a and 13b are rotated counterclockwise by a drive motor (not shown). The transport portion 13 unrolls and transports the roll paper RP, which is a medium, from the roll body RB held by the roll body holding portion 11. The roll paper RP is transported along a transport path indicated by a dashed-dotted line, and reaches the support portion 17 from the transport roller 13a through the transport roller 13b. Further, even when cut paper is applied as the medium, the transport path for the cut paper inside the housing 19 is the same as that for the roll paper RP.

The support portion 17 is a so-called platen capable of supporting the roll paper RP or the cut paper that is the medium, and is disposed below the transport path. A printing surface of the medium on which printing is performed is directed upward, and a back side of the print surface is supported by the support portion 17. The medium is transported in the +Y direction in the support portion 17.

The printing unit 15 is attached below the carriage 12. The printing unit 15 is disposed to face the support portion 17 in the vertical direction. The printing unit 15 performs recording, that is, printing on the medium transported by the transport portion 13.

The printing unit 15 is an inkjet head. Although not shown, the printing unit 15 has a nozzle surface at a position facing the support portion 17. A plurality of nozzle sequences including a plurality of nozzles are disposed on the nozzle surface. Each nozzle sequence individually corresponds to one of the ink cartridges described above. Each color ink supplied from each ink cartridge is ejected from a predetermined nozzle in the corresponding nozzle sequence and adhered to the medium on the support portion 17.

Although not shown, the carriage 12 is supported by a frame member and is moved back and forth in the direction along the X-axis relative to the support portion 17 by a drive mechanism. The printing unit 15 is moved back and forth relative to the support portion 17 together with the carriage 12.

Printing is performed on the medium by moving the printing unit 15 back and forth along the X-axis relative to the medium while transporting the medium in the +Y direction, and adhering ink to the medium from the printing unit 15 at a predetermined timing. Accordingly, an image, text, pattern, color, or the like is formed on the medium, and the medium becomes the printed matter.

The printed matter is transported in the +Y direction by the transport portion 13 and discharged from the paper discharge port 32 to the outside of the housing 19. Thus, printing is performed on the roll paper RP and the cut paper.

As illustrated in FIG. 3, the second cover 22 includes a cover body 220 and a cover attachment portion 222.

The cover body 220 is an elongated member along the X-axis. The cover body 220 is formed of, for example, plastic. In the present embodiment, the cover body 220 is a hollow plastic member for the purpose of weight reduction. The cover body 220 is attached to the cover attachment portions 222 at an end in the +X direction and an end in the −X direction (not shown).

The cover attachment portions 222 form a pair and support the end in the +X direction and the end in the −X direction of the cover body 220. Each cover attachment portion 222 is supported by the first cover 21. Specifically, the cover attachment portions 222 in the pair are disposed at an end in the counterclockwise direction viewed from the −X direction and both ends in the direction along the X-axis in the first cover 21. That is, the cover body 220 is attached to the first cover 21 via the cover attachment portions 222.

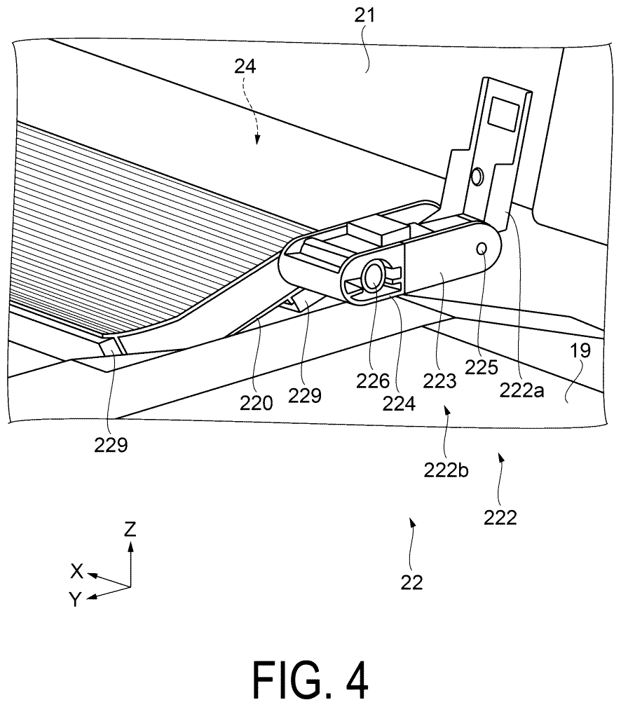

As illustrated in FIG. 4, the cover attachment portion 222 includes a first portion 222a and a second portion 222b. The second portion 222b includes a third portion 223 coupled to the first portion 222a, and a fourth portion 224 coupled to the cover body 220. The second portion 222b has a first pivot shaft 225 and a second pivot shaft 226. FIG. 4 shows the printing apparatus 1 in a state in which the cut paper is printed.

As described above, the cover attachment portion 222 is disposed at both ends of the first cover 21 in the direction along the X axis. Hereinafter, the cover attachment portion 222 at the end in the −X direction between both the ends will be described, and description of the cover attachment portion 222 at the end in the +X direction will be omitted. The cover attachment portion 222 at the end in the −X direction and the cover attachment portion 222 at the end in the +X direction have the same configuration and function, and have shapes symmetrical with respect to a plane along the YZ plane.

The first portion 222a is fixed to the first cover 21. The first portion 222a and the second portion 222b are coupled via the first pivot shaft 225. Specifically, the first pivot shaft 225 is disposed along the X axis. The first pivot shaft 225 pivotably engages an end of the first portion 222a in the approximate −Z direction with an end of the third portion 223 in the second portion 222b in the −Y direction. This allows the second portion 222b to pivot relative to the first portion 222a with the first pivot shaft 225 as a pivot center. The second portion 222b is manually pivoted by the operator of the printing apparatus 1.

The third portion 223 and the fourth portion 224 are adjacent to each other at a boundary along the XZ plane in a posture of the second cover 22 illustrated in FIG. 4. In the second portion 222b, the third portion 223 is disposed in the −Y direction, and the fourth portion 224 is disposed in the +Y direction.

The second portion 222b and the cover body 220 are coupled via the second pivot shaft 226. Specifically, in the state illustrated in FIG. 4, the end of the cover body 220 in the approximately −Y direction is supported by the second pivot shaft 226. The second pivot shaft 226 is disposed along the X axis in the fourth portion 224. The second pivot shaft 226 pivotably supports the cover body 220 with respect to the second portion 222b. The second pivot shaft 226 is made of metal. A material of the second pivot shaft 226 is not particularly limited, but may be aluminum, aluminum alloy, or the like. The cover body 220 is also manually pivoted by the operator of the printing apparatus 1.

The cover body 220 has two gap sealing members 229. Each gap sealing member 229 is an elongated member along the X-axis. The gap sealing members 229 are formed of an elastic material. The material of the gap sealing members 229 is not particularly limited, but examples thereof may include a foam material such as resin and rubber. A function of the gap sealing members 229 will be described later.

When printing is performed on the cut paper, the cut paper is supplied to the medium supply port 24 from the outside of the printing apparatus 1, more specifically, from approximately the +Y direction of the first cover 21 and from the upper side, through an area between the cover body 220 and the first cover 21.

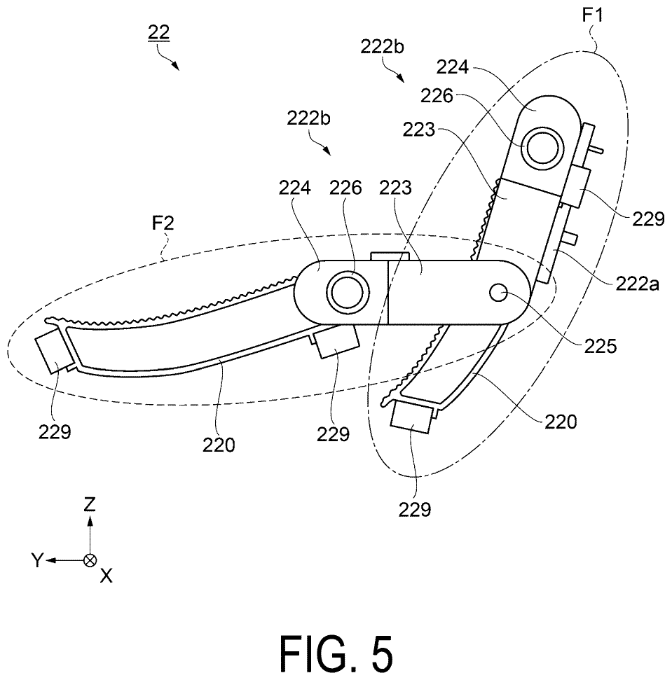

As illustrated in FIG. 5, the form of the second cover 22 may be changed into a form F1 surrounded by a dashed-dotted line and a form F2 surrounded by a broken line. In the forms F1 and F2, the first portion 222a is fixed to the first cover 21 (not shown) without change in position. In FIG. 5, the two forms F1 and F2 are shown to overlap each other. Further, in the following description of FIG. 5, a state viewed from the −X direction will be described unless otherwise specified.

The form F1 is applied when the roll paper RP is printed. In the form F1, the fourth portion 224 is above the third portion 223, and the second portion 222b is along the first portion 222a. In this case, the second pivot shaft 226 is located above the first pivot shaft 225, and approximately an upper half of the cover body 220 overlaps the third portion 223 and the fourth portion 224. Approximately a lower half of the cover body 220 protrudes downward.

In the form F1, the gap sealing member 229 disposed near the second pivot shaft 226 protrudes in the approximately −Y direction from the second portion 222b. Further, the gap sealing member 229 disposed at the end of the cover body 220 in a −Z direction is disposed to protrude approximately downward.

The form F2 is applied when the cut paper is printed. In the form F2, the second portion 222b is pivoted counterclockwise on the first pivot shaft 225 compared to the form F1, and the second portion 222b is laid down along the Y axis. In addition, the cover body 220 is pivoted clockwise on the second pivot shaft 226 and is along the Y axis. In the form F2, the second portion 222b is separated from the first portion 222a.

This makes it possible for the cover attachment portion 222 to displace the cover body 220 between a first position and a second position, which will be described later.

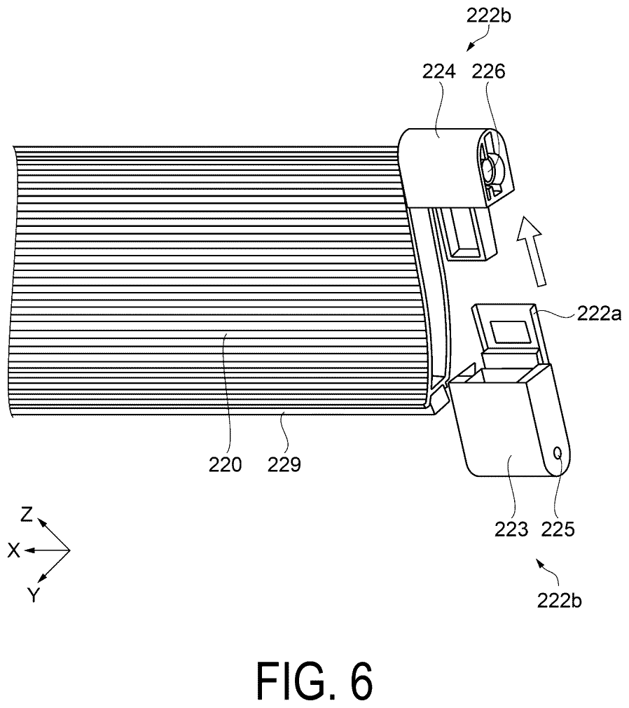

As illustrated in FIG. 6, the fourth portion 224 is detachable from the third portion 223. That is, the cover body 220 and the fourth portion 224 are separated from the printing apparatus 1 by pulling out the fourth portion 224 in a direction indicated by an arrow from the first portion 222a and the third portion 223.

When the cover body 220 is removed from the printing apparatus 1, the cover body 220 can be easily transported or stored, and maintenance work or the like can be easily performed due to removal of the cover body 220. This improves the convenience of the operator of the printing apparatus 1.

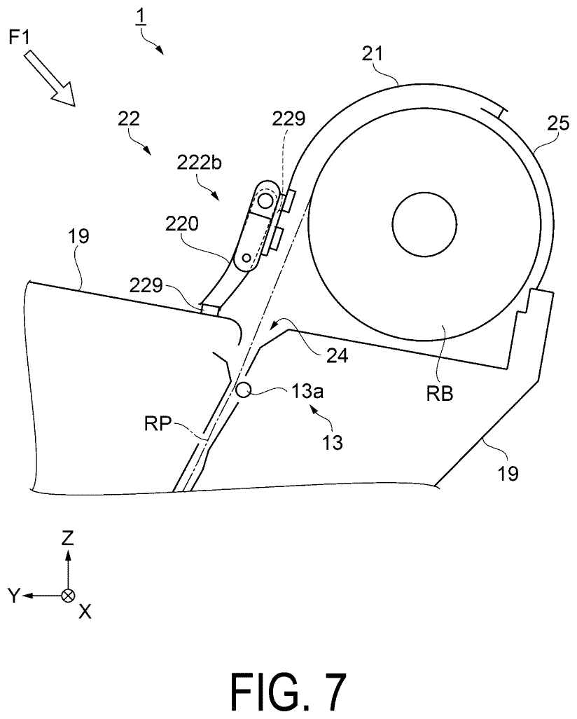

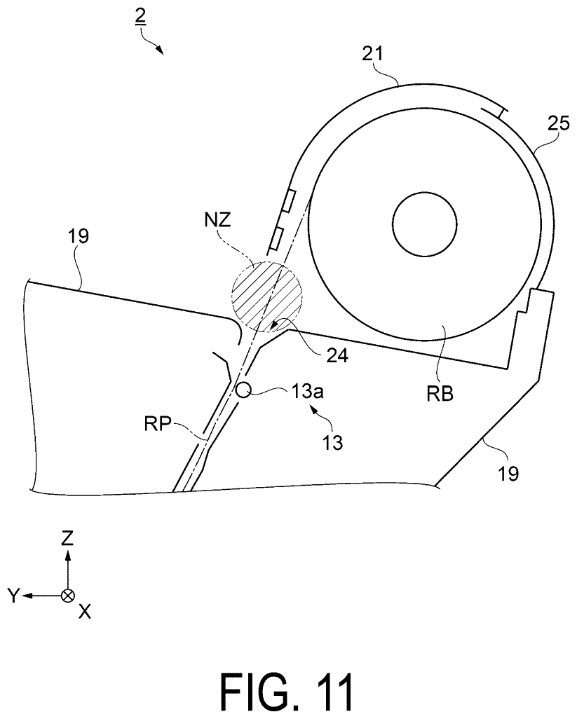

Here, a printing apparatus 2 of the related art, which is a comparative example, will be described with reference to FIG. 11. As illustrated in FIG. 11, the printing apparatus 2 according to the comparative example has a configuration in which the second cover 22 is omitted from the printing apparatus 1 according to the present embodiment, and other configurations are the same as those of the printing apparatus 1. The other configurations of the printing apparatus 2 are denoted by the same reference signs as those of the printing apparatus 1, and repeated description will be omitted. In the description of FIG. 11 and the following descriptions of FIGS. 7, 8, and 9, a state viewed from the −X direction will be described unless otherwise specified.

In the printing apparatus 2, when the first cover 21 is closed and printing is performed on the roll paper RP, an area between a substantially lower end of the first cover 21 and the medium supply port 24 is exposed to the outside of the printing apparatus 2. In other words, even when the first cover 21 is closed, the first cover 21 does not cover at least a portion of the medium supply port 24. An area of the medium supply port 24 that is not covered by the first cover 21 when the first cover 21 is closed is called a non-covered area NZ.

Since the non-covered area NZ is exposed to the outside, foreign matter such as dust can easily enter the housing 19 from the non-covered area NZ. This makes it difficult to reduce the occurrence of printing defects.

On the other hand, as illustrated in FIG. 7, in the printing apparatus 1, the non-

covered area NZ can be covered with the second cover 22. Specifically, when printing is performed on the roll paper RP, the first cover 21 is turned counterclockwise and closed, and the second cover 22 is in form F1. The first cover 21 is manually opened and closed by the operator of the printing apparatus 1. The first portion 222a is not illustrated in FIG. 7.

When the transport portion 13 unrolls and transports the roll paper RP from the roll body RB held by the roll body holding portion 11, that is, when printing is performed on the roll paper RP, the cover body 220 is supported by the second portion 222b and is at the first position illustrated in FIG. 7. When printing is performed on the roll paper RP, the first cover 21 is at a third position at which the roll body RB held by the roll body holding portion 11 is covered. The third position refers to a position at which the first cover 21 illustrated in FIG. 7 is closed.

When printing is performed on the roll paper RP, the first cover 21 is closed to the third position, the second cover 22 is in the form F1, and the cover body 220 is at the first position. This allows the non-covered area NZ to be covered by the cover body 220.

When the cover body 220 is at the first position, the two gap sealing members 229 block a gap between the first cover 21 and the cover body 220 and a gap between the cover body 220 and the housing 19. As described above, since the gap sealing member 229 is formed of an elastic material, the gap sealing member 229 blocks the gap by being crushed and deformed. This further curbs entrance of dust into the inside of the housing 19, and further curbs the occurrence of printing defects.

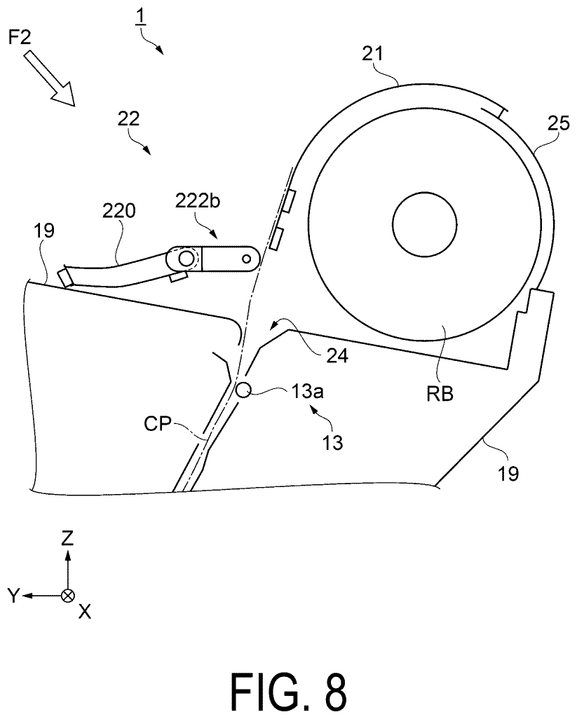

As illustrated in FIG. 8, even when cut paper CP is printed, the first cover 21 is closed to the third position. In addition, the second cover 22 is in the form F2. Further, the cover body 220 is at the second position illustrated in FIG. 8, which is a position when the cut paper CP is supplied and transported. In this case, the cover body 220 is also supported by the second portion 222b. The cover body 220 can be displaced between the first position and the second position. The first portion 222a is not illustrated in FIG. 8.

The second position is a position at which the cover body 220 is farther away in the +Y direction from the first cover 21 than the first position. When the cover body 220 is at the second position, a gap is generated between an end of the first cover 21 in a counterclockwise direction and the second cover 22, that is, in the non-covered area NZ. In other words, the cover body 220 does not block the transport path for the cut paper CP in the non-covered area NZ at the second position.

Therefore, the cut paper CP is transported to the support portion 17 (not shown) along the transport path for the cut paper CP indicated by a dashed-dotted line. Specifically, the end of the first cover 21 in the counterclockwise direction functions as a guide that supports the cut paper CP when the transport portion 13 transports the cut paper CP. The cut paper CP is pulled substantially downward along the end of the first cover 21 and a surface in the substantially +Y direction near the end, and is moved from the medium supply port 24 to the inside of the housing 19. The transport portion 13 can transport the cut paper CP as a medium from the outside of the housing 19 to the support portion 17 via the non-covered area NZ.

Thus, the cover body 220 of the second cover 22 is displaced to the second position, and the cover body 220 is moved away from the first cover 21, thereby ensuring the transport path for the cut paper CP to the inside of the housing 19. Accordingly, the cover body 220 of the second cover 22 does not get in the way at the time of printing on the cut paper CP. Since the first cover 21 is a guide, the transportability of the cut paper CP into the housing 19 is improved. It is possible to perform printing using the cut paper CP while curbing entrance of dust at the time of printing on the roll paper RP.

There is no need to attach or detach the second cover 22 when the roll paper RP is applied and a case where the cut paper CP is applied, thereby improving the convenience of the operator of the printing apparatus 1. Even when printing is performed on the cut paper CP, the first cover 21 covers the roll body RB to protect the roll body RB from dust, mist of ink generated by the printing unit 15, or the like. Since the second cover 22 is supported by the first cover 21 and is displaced together with the first cover 21, the operator does not need to displace the second cover 22 and the first cover 21 individually.

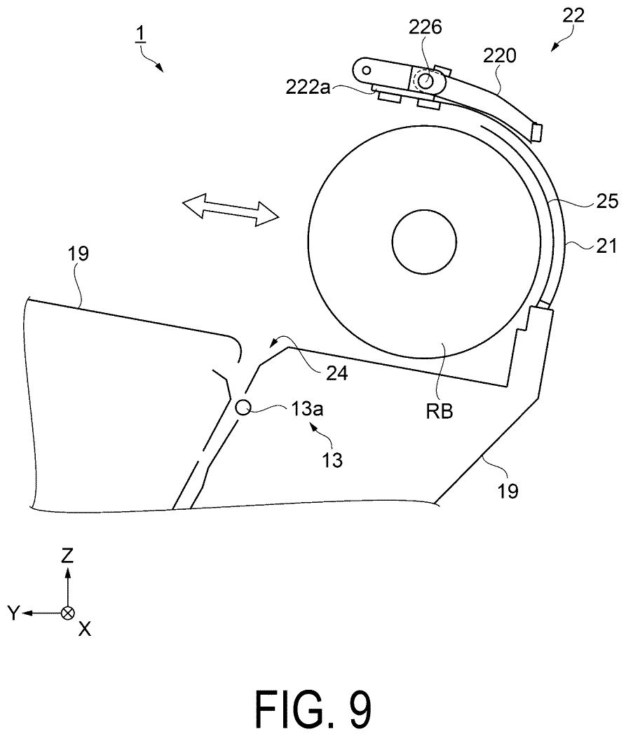

As illustrated in FIG. 9, the first cover 21 is displaceable to a fourth position at which the first cover is located when the roll body RB held by the roll body holding portion 11 is replaced, and the third position described above. In detail, when the roll body RB is replaced, the first cover 21 is manually moved clockwise and opened to the fourth position in FIG. 9. At the fourth position, the circumferential surface of the roll body RB directed to the +Y direction is exposed. This makes it possible for the operator of the printing apparatus 1 to move the roll body RB in the +Y direction as indicated by an arrow to remove the roll body RB, and mount another roll body RB from the direction indicated by the arrow.

The first portion 222a of the second cover 22 is supported by the end of the first cover 21 in the counterclockwise direction. Therefore, the first portion 222a can be displaced together with the first cover 21 as the first cover 21 displaces between the third position and the fourth position. Therefore, it is difficult for the second cover 22 to get in the way at the time of replacing the roll body RB, and the workability of replacement can be improved.

Further, it is preferable to displace the cover body 220 before and after the first cover 21 is at the fourth position at the time of replacing the roll body RB. Specifically, the cover body 220 is pivoted clockwise on the second pivot shaft 226 from the first position. Accordingly, the cover body 220 does not protrude in the +Y direction from the end of the first cover 21 in the counterclockwise direction, and replacement work is facilitated.

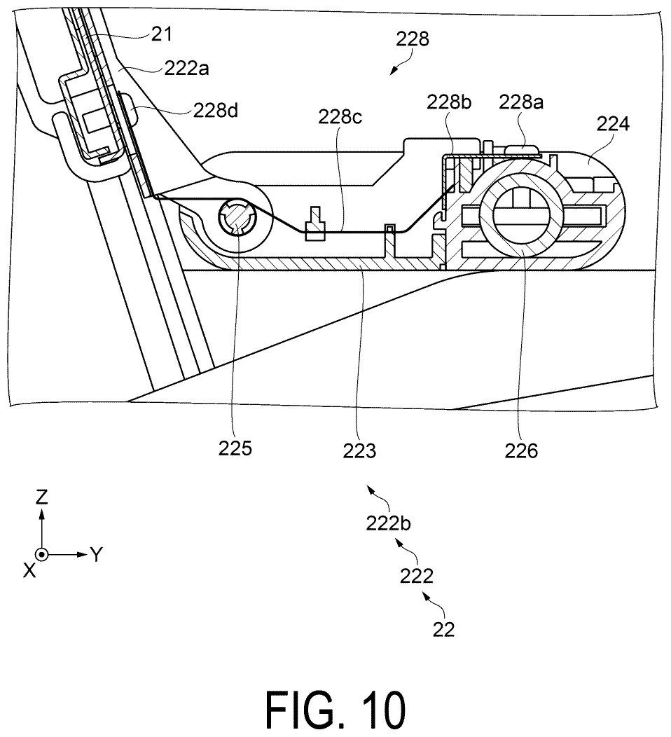

As illustrated in FIG. 10, the second portion 222b of the cover attachment portion 222 has a grounding member 228 that grounds the second pivot shaft 226. The grounding member 228 is disposed on the cover attachment portion 222 at both the ends of the first cover 21 in the direction along the X axis. FIG. 10 shows a state in which the second cover 22 is in the form F2. In the description of FIG. 10, a state viewed from the +X direction will be described unless otherwise specified.

The grounding member 228 includes portions 228a, 228b, 228c, and 228d. The portions 228a, 228b, 228c, and 228d are formed of conductive metal.

The portion 228a is a screw, and is electrically coupled to the second pivot shaft 226, which is made of conductive metal. The portion 228b electrically couples the portion 228a to the portion 228c.

The portion 228c is interposed between the portion 228b and the portion 228d, and electrically couples the portion 228b to the portion 228d. The portion 228c is wound around the periphery of the first pivot shaft 225, and also functions as a spring member.

Therefore, the grounding member 228 is deformable to follow the displacement of the second cover 22 when the second cover 22 displaces between the first position and the second position described above while maintaining an electrical coupling. That is, even when the cover attachment portion 222 is pivoted counterclockwise on the first pivot shaft 225 to the above-described form F1, the portion 228c is deformed and the electrical coupling between the portion 228b to the portion 228d is maintained.

The portion 228d is a screw and is electrically coupled to a conductive structural member of the printing apparatus 1. Although not shown, the structural member is grounded via a wiring. Thus, it is possible to secure the second pivot shaft 226 with a simple configuration.

According to the present embodiment, the following effects can be obtained.

It is possible to curb the entrance of dust from the medium supply port 24 and reduce the occurrence of the printing defects. Specifically, the non-covered area NZ that is not covered even when the first cover 21 is closed is covered with the second cover 22, thereby curbing entrance of dust into the housing 19. Therefore, it is possible to provide the printing apparatus 1 that reduces the occurrence of the printing defects.

Since the second cover 22 has a relatively simple configuration, the second cover 22 can be attached to an apparatus of the related art as a retrofit.

What is claimed is:

1. A printing apparatus comprising:
a roll body holding portion configured to hold a roll body of roll paper wound in a roll shape as a medium;
a transport portion configured to unroll and transport the medium from the roll body held by the roll body holding portion;
a printing unit configured to perform recording on the medium transported by the transport portion;
a support portion disposed to face the printing unit and configured to support the medium;
a housing configured to accommodate the transport portion, the printing unit, and the support portion therein; and
a first cover configured to be opened and closed and cover the roll body held by the roll body holding portion when the first cover is closed, wherein
the roll body holding portion and the first cover are disposed above the housing,
a medium supply port for supplying the medium unrolled from the roll body to the inside of the housing is installed on an upper surface of the housing,
the first cover does not cover at least a portion of the medium supply port in a state in which the first cover is closed, and
when an area of the medium supply port not covered by the first cover when the first cover is closed is defined as a non-covered area, a second cover configured to cover the non-covered area is included.

2. The printing apparatus according to claim 1, wherein
the transport portion is configured to transport cut paper as the medium from the outside of the housing to the support portion through the non-covered area,
the second cover includes a cover body configured to cover the non-covered area,
the cover body is displaceable between a first position at which the cover body is located when the transport portion unrolls and transports the roll paper from the roll body held by the roll body holding portion and a second position at which the cover body is located when the transport portion transports the cut paper,
and the cover body does not block a transport path for the cut paper in the non-covered area at the second position.

3. The printing apparatus according to claim 2, wherein
the first cover functions as a guide configured to support the cut paper when the transport portion transports the cut paper, and
the second position is a position at which the cover body is farther away from the first cover than the first position.

4. The printing apparatus according to claim 2, wherein
the second cover includes a cover attachment portion,
the cover body is attached to the first cover via the cover attachment portion, and
the cover attachment portion is configured to displace the cover body to the first position and the second position.

5. The printing apparatus according to claim 4, wherein the cover body includes a gap sealing member configured to block a gap between the first cover and the cover body and a gap between the cover body and the housing when the cover body is at the first position.

6. The printing apparatus according to claim 4, wherein
the cover attachment portion includes a first portion fixed to the first cover, and a second portion configured to support the cover body at the first position and the second position,
the second portion includes a third portion coupled to the first portion and a fourth portion coupled to the cover body, and
the fourth portion is detachable from the third portion.

7. The printing apparatus according to claim 6, wherein
the first cover is displaceable to a third position at which the roll body held by the roll body holding portion is covered and a fourth position at which the first cover is located when the roll body held by the roll body holding portion is replaced, and
the first portion is displaceable together with the first cover as the first cover is displaced between the third position and the fourth position.

8. The printing apparatus according to claim 6, wherein
the second portion includes
a first pivot shaft configured to pivotably engage the first portion with the second portion,
a second pivot shaft configured to pivotably support the cover body relative to the second portion, the second pivot shaft being made of metal, and
a grounding member configured to ground the second pivot shaft, and
the grounding member is deformable to follow the displacement of the second cover when the second cover is displaced between the first position and the second position.
